(19) United States
(12) Patent Application Publication
(10) Pub. No.: US 2011/0265126 A1
(43) Pub. Date: Oct. 27, 2011

(54) SYSTEMS AND METHODS FOR GENERATING A FAVORITES LIST OF MOVIE TITLES

(76) Inventors: Alan Rouse, Lawrenceville, GA (US); Charles Dasher, Lawrenceville, GA (US)

(21) Appl. No.: 12/764,161

(22) Filed: Apr. 21, 2010

(51) Int. Cl. G06F 13/00; H04N 5/44

(52) U.S. Cl. 725/61; 348/734; 725/92; 348/E05.096

(57) ABSTRACT

In one embodiment, a system is disclosed allowing a cable subscriber to identify a movie title that is available for viewing using a VOD service offered by a cable service provider to be included in a list of favorite movie titles, where the list is associated with the viewer. The viewer can be informed of a point in time when one or more movies on the viewer's favorite list will no longer be available for viewing using the VOD service. In another embodiment, the viewer can be informed of a point in time when one or more movies on the viewer's favorite list will be available for viewing using the VOD service. The viewer can request recommendation of similar movie titles relative to a title identified in the list of favorite movie titles. Various other functions can be indicated by the viewer when viewing the list.

### FIELD OF INVENTION

This invention generally pertains to systems and methods for providing a cable subscriber with a list of movie titles available in a video on-demand library in a cable service provider along with indications of availability limitations.

### BACKGROUND OF THE INVENTION

Video on-demand (VOD) provides a virtual library of movie titles accessible to cable system viewers that can be viewed at their choosing. VOD provides a service of convenience allowing viewers to select what move than can watch and when. By storing digital video files in a central server in the cable services provider's headend, the user does not have to maintain individual personal copies, and can request the movies as desired. Further, the cable service provider can continuously augment the library by adding movie titles as they become available.

However, as the list of movies (referred to as “titles”) in the VOD library grows, two aspects become increasing important. First, the user-interface to search and select a title becomes more difficult. A list with a few dozen titles can be easily scanned by a viewer, but when the list comprises hundreds or even a thousand titles, then finding the desired title can be onerous. Thus, increasingly sophisticated user-interfaces are required to provide easy navigation of the VOD menus and provide ready access to desired movies.

Second, as movie titles are added, increasing amounts of disk storage are required to store the digital video files associated with the movie title. Even in light of modem compression techniques, the increasing number of movies represents an increasing cost of storage for the cable service provider. Other costs may be associated with maintaining a title, including licensing fees, management costs, etc.

Thus, many cable service providers periodically cull or remove titles from the VOD library. These titles may be removed based on lack of viewing interest, or for other reasons. However, viewers are not always aware when a title is removed from the library. Typically, titles removed from the library are not advertised to the viewer. Viewers may be under the impression that a certain movie is present in the library, and schedule a time to watch it at a later date only to then find out that the movie was removed from the library. In an inverse situation, a viewer may desire to watch a movie that has been released in the movie theaters, but has not yet been added to the video library. When the movie is added by the cable service provider, the viewer may not be aware of this, and thus is not able to view the movie as soon as they desired. Thus, improved systems and methods are required for notifying a viewer of when a movie title is available, or conversely, when a move title no longer is available.

### BRIEF SUMMARY OF THE INVENTION

In one embodiment, the present invention provides a viewer with a list of favorite movie titles (“favorites list”) along with an indication of viewing limitations for a movie title, or with an indication of when the title may be viewed. More specifically, in one embodiment, a user can create a favorites list of movie titles, and the system will provide an indication in that list of when any particular title will be removed from the library. In another embodiment, the user can create a favorite list of movie titles, and the system will provide an indication when that particular title will be available for viewing in that library or when it will no longer be available for viewing. In various embodiments, this information can be indicated by icons and/or dates shown on the list, or can be communicated to the viewer via messaging of some sort (e.g., email or text messages). This summary describes only a portion of the various embodiments described herein, and other embodiments, which are within the scope of the invention, are recited in the claims.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates one embodiment of a Favorites List menu screen,

FIG. 2 illustrates one embodiment of a system providing a Favorites List,

FIG. 3 illustrates one embodiment of the processing functions associated with the Favorites List menu, and

FIG. 4 illustrates one embodiment of a system providing the Favorites List.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

Although certain methods, apparatus, systems, and articles of manufacture have been described herein, the scope of coverage of this patent is not limited thereto. To the contrary, various embodiments encompass various apparatus, systems, and articles of manufacture fairly falling within the scope of the appended claims either literally or under the doctrine of equivalents.

As should be appreciated, the embodiments may be implemented in various ways, including as methods, apparatus, systems, or computer program products. Accordingly, the embodiments may. take the form of an entirely hardware embodiment or an embodiment in which computing hardware, such as a processor or other special purpose devices, is programmed to perform certain steps. Furthermore, the various implementations may take the form of a computer program product on a computer-readable storage medium having computer-readable program instructions embodied in the storage medium. Any suitable computer-readable storage medium may be utilized including but not limited to hard disks, CD-ROMs, optical storage devices, or magnetic storage devices.

The embodiments are described below with reference to block diagrams and flowchart illustrations of methods performed using computer hardware, apparatus, systems, and computer-readable program products. It should be understood that the block diagrams and flowchart illustrations, respectively, may be implemented in part by a processor executing computer-readable program instructions, e.g., as logical steps or operations executing on a processor in a computing system or other computing hardware components. These computer-readable program instructions are loaded onto a computer, such as a special purpose computer or other programmable data processing apparatus, to produce a specifically-configured machine, such that the instructions which execute on the computer or other programmable data processing apparatus implement the functions specified in the flowchart block or blocks.

### Service Overview

VOD movie libraries provide a convenient service to cable subscribers by allowing a variety of movies to be available to cable subscribers for viewing. Typically, a VOD menu provides a list of the movie titles, but navigating the list of titles becomes more difficult as the list becomes longer. As the list grows longer, various techniques for searching for titles are possible and required for practicality. Cable service providers by necessity periodically cull the list of titles in the VOD library which may not be popular, or for other reasons. Frequently, the cable service provider knows when a title will be removed, but the subscriber may not be aware of this. Thus, a subscriber may search for a movie, which was previously available in the VOD library, and may be unable to locate the movie because it is no longer available. Providing the user with an indication of when a movie is no longer available is desirable, but then this requires listing the movie, and would merely result in more information the viewer would have to review.

The system addresses this aspect in one embodiment by generating and maintaining a “Favorites List” for a viewer along with limitations associated with movie title availability. Typically, the Favorites List comprises movie titles, but other identifiers can be used, including shorthand text references to the titles. These Favorites Lists are typically created and maintained for each viewer requesting such a list where the viewer has an account with the service provider.

Although the invention is disclosed herein in terms of a cable service provider, the scope of the invention is not limited to such, unless otherwise limited by the claim terms. Specifically, the invention can be applied to satellite video service providers, wireless service providers and other service providers using a variety of technologies.

In one embodiment, the Favorites List is associated with a viewer as identified by a viewer identifier or viewer account. This allows multiple individuals in a service location (e.g., a household) to have distinct Favorites Lists. Alternatively, a single list can be allowed, which avoids the viewer from having to identify themselves explicitly. In other embodiments, the cable service provider (“CSP”) can incorporate movie titles selected by the viewer to seed the initial list prior to the user explicitly requesting such a list. Thereafter, once Created, the CSP can update the Favorites List as movies as viewed, or as explicitly requested by the viewer to be added to the Favorites List. The system providing the Favorites List can provide indications or notifications to the viewer that movies on the list will be unavailable past at a certain time point in the future. This threshold time point can be configurable by the viewer or the system, so as to provide an appropriate indication of when movies when be unavailable (e.g., the title will be removed from the list in either two days, two weeks, or two months). In some embodiments, if the programs are associated with a fee (e.g., pay-per-view), the service provider may also indicate a discount to be applied during this time period when the program is selected for viewing. In other embodiments, the system can inform the user when previously unavailable movie titles will become available. In other embodiments, the system can recommend titles based on the Favorites List where the titles may be of potential interest to the viewer.

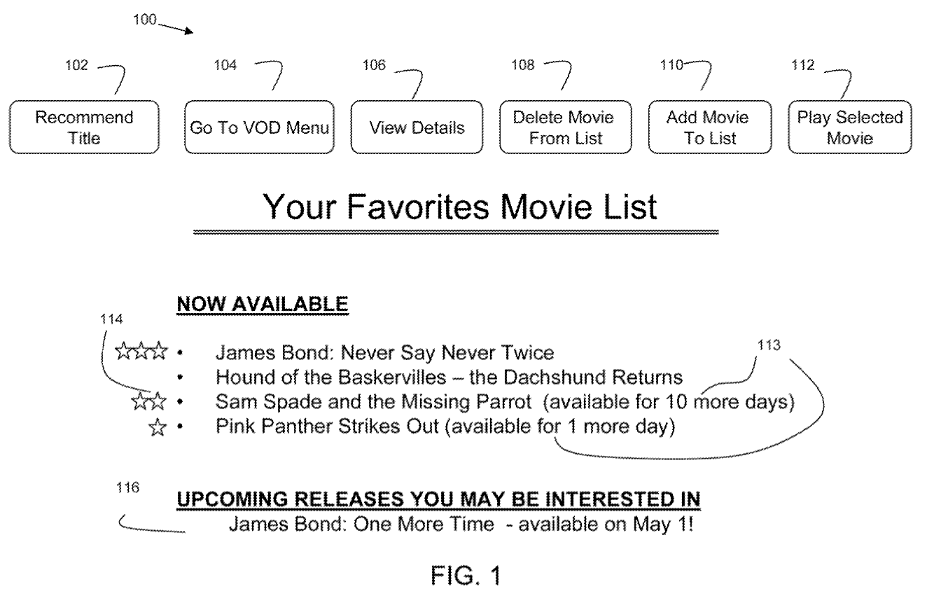

In one embodiment, the Favorites List is a list of movie titles, as shown in FIG. 1. In other embodiments, the Favorites List comprises a list of movie titles that feature a common aspect, such a common movie actor, theme, etc. In various embodiments, the viewer may be required to identify themselves to allow the system to provide the appropriate Favorite List for the service location (if multiple Favorite Lists are associated with a single set top box or group of set top boxes). Thus, the viewer may be asked to initially identify themselves in some manner.

In the exemplary Favorites List 100 shown in FIG. I, various function keys 102-112 are illustrated, which allow the user to perform various functions. Some of the functions operate on a selected title. For example, the “Recommend Similar Title” function 102 allows the user to request a search engine in the CSP to use the selected movie title to recommend other titles in the VOD library, which may be of the liking to the viewer. This can be based on finding movies with the same actors, similar plot lines, common directors, or other movies selected by other viewers who selected the present movie. Other algorithms for determining a “similar” title can be utilized.

The “Go To VOD Menu” function 104 allows the user to jump to the VOD menu, where the full list of movie titles that are available in the VOD library are displayed. The Favorites List can be accessed, in one embodiment, from the VOD menu and the viewer can return back to the VOD menu from the Favorites List. The “View Details” function 106 allows the user to see additional details of the selected movie title including actors, year released, rating, plot summary, etc. The “Delete Movie From List” function 108 allows the user to remove a movie from the list. Conversely, the “Add Movie To List” function 110 allows the user to enter information about a movie to add to the, list. This can be done via text box, or other means known in the art. Finally, the “Play Selected Movie” function 112 allows the user to view the selected movie. Typically the user will use the remote control to navigate the screen to identify a movie, and then perform the function by selecting the appropriate box. Some functions, such as “Go To VOD Menu” can be invoked without selecting a movie. Those skilled in the art will readily recognize that various navigation techniques can be used.

The Favorite List also includes a list of titles 114, which can be the exact title of the movie, or an abstracted form of the title. Other types of indicators, including alphanumeric descriptors can be used (e.g., rating, year, etc.). In one embodiment, the titles are segregated into those which are available for viewing, and those which will be available for viewing 116. The titles available for viewing may also include a user-indicated rating indicator (e.g., a number of stars) or other identifier to remind the viewer how well the movie was liked. The titles in the list can be movies which the viewer has seen previously, but not via the CSP's VOD service. For example, the viewer may have seen a movie in the theaters, and has included it in their Favorites List, but the viewer has not yet seen the movie via the CSP's VOD service because the title has not yet been added to the VOD library. Thus, in one embodiment, the Favorites List could include titles which are not presently in the VOD library.

The list also includes information as to the availability of the movie in the VOD library. Specifically, information 113 may be added by the system to indicate how much longer the movie title may be available. This may be indicated as the number of days until it will no longer be available, or a last available date may be indicated. In the case of the former, the system would have to calculate the remaining days each time the Favorites List is presented, whereas with a removal date, this is not required. Obviously, once a movie has been removed from the VOD library, the Favorites List should indicate the movie is no longer available or it may simply remove the movie title from the list. The viewer can be informed of the removal upon initially accessing the Favorites List. The Favorites List may also utilize different colors or subheadings to indicate whether the movie title has been previously viewed, or is about to be removed, or will be shortly added.

The list 100 may include titles 116 which the viewer has not seen, and which are not yet available in the VOD library, but which are planned or likely to be made available via the VOD library. This information may include a scheduled availability date. The system may indicate or recommend titles that are “similar” to previously selected titles in the list. The determination of a “similar” title is based on an algorithm used by the Favorite List Management System (“FLMS” or “System”) to ascertain that a movie may be enjoyed by the viewer. This could be based on the same algorithm used to determine a “Recommended Similar Title” as previously discussed. Thus, in this embodiment, because the viewer has previously identified a “James Bond” movie in the favorites section, the FLMS may identify another move of the “James Bond” genre as an upcoming release to bring to the attention of the viewer. The viewer may then select the title, and invoke the “Add Movie to List'” function.

Other variations regarding the list format and functionality are possible, and the disclosed embodiment can be modified to incorporate other variations that are apparent to one skilled in the art.

### System Architecture

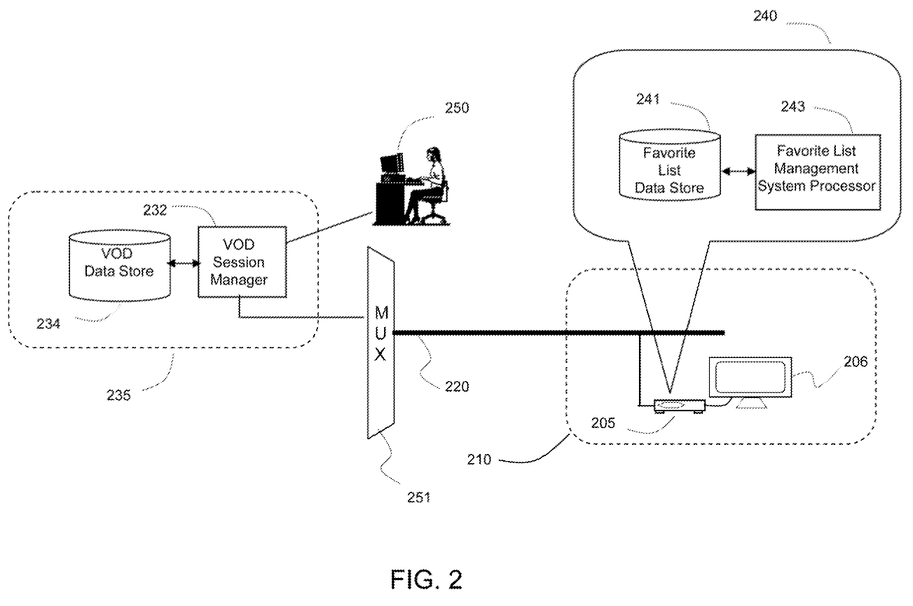

The FLMS is the system that manages the Favorites List and is responsible for managing the data used to generate the Favorite List displays. One embodiment of the ELMS is shown in FIG. 2. In FIG. 2, the components can be divided into those components residing in the CSP headend and those components residing on the customer's premises. The headend comprises a VOD system 235 comprising a VOD Session Manager 232 and a VOD Data Store 34. The VOD Session Manager receives the requests from the viewer, provides the menus and responses, and instructs the VOD Data Store to stream a selected program to the viewer. The VOD Session Manager is aware of the various titles stored as video files in the VOD data store, and may incorporate an interface to an administrative management system 250 used for adding and removing titles as necessary. In one embodiment, the VOD system is aware of when movies will be removed, or when they will be available via information provided by an administrative management system 240. Thus, the VOD system may maintain title data along with an associated removal date or availability date. The removal date or availability data can be collectively considered as “movie title availability data.” In the case of an availability date, the title data may reflect a title that will be made available to VOD service users, but is not presently stored in the VOD system.

In one embodiment the VOD System 235 periodically downloads the list of VOD titles and other movie title availability data to the set top box. This may use existing carousel techniques for data transfer, or other out-of-band information transfer techniques, including a DOCSIS channel. When the user invokes the VOD service, the set top box generates a menu of VOD titles based on the locally stored movie title data. Once the viewer selects the program, the set top box then requests the video asset to the VOD system 235, which processes the request and downloads the program on a particular channel. The VOD system 235 then informs the set top box as to which channel to tune in order to review the movie.

Because of the close relationship between the System implementing the Favorite List and the system implementing the VOD service, there is a close coupling of these systems. In this embodiment, the Favorites List Management System 240 resides in the set top box and relies on information provided to the set top box as part of the VOD service. In other embodiments, the FLMS can be implemented by augmenting the VOD application itself with new functionality executing on the existing processor in the set top box. Still other embodiments may implement the FLMS in the headend using new or existing processing equipment. One skilled in the art will recognize that a number of variations are possible.

The information regarding upcoming new movie entries and removal dates for titles are made available to the FLMS 240. There, a processing program executing on the FLMS processor 243 executes logic for processing the data to update the Favorites List, which may be stored in the Favorite List Data Store 241.

The other components in the headend include the multiplexor 251, which interfaces with the cable distribution plant 220, which can utilize various technologies and topologies to accomplish distribution of video and conveying of signaling information. The viewer's premises equipment 210 is illustrated as comprising a set top box 205 and a television 206.

During operation, the user typically requests the VOD service using the remote control (not shown), which conveys to the set top box the request for the VOD service. The VOD application executing in the set top box then presents the VOD menu to the user. The invocation of the Favorites List service can be a selection that is indicated from within the VOD menu, resulting in the viewer being presented with their Favorites List. Alternatively, the Favorites List can be provided as its own standalone function that is executed by pressing a dedicated function key on the remote control. Typically, there is the capability of navigating from the VOD menu to the Favorites List menu, and vice versa.

### Process Flow

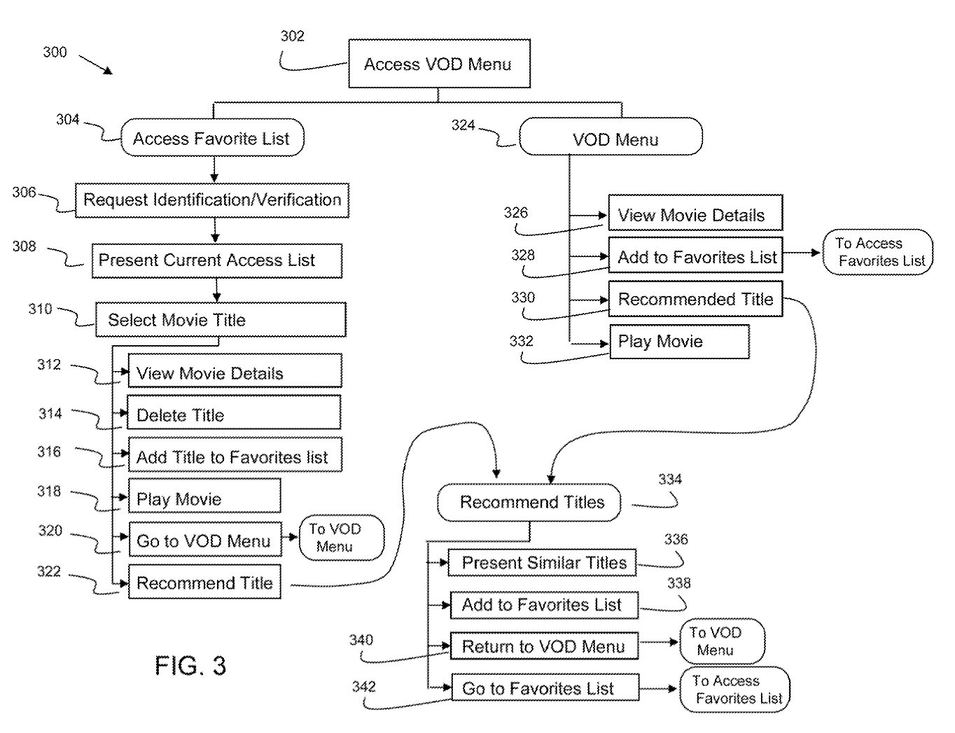

FIG. 3 illustrates one embodiment of the viewer's navigation capabilities and process flow of the Favorites List service relative to the VOD service. In this embodiment 300, the viewer invokes the VOD service at step 302. Service invocation may occur by pressing a button on the remote control, which triggers execution of the VOD set top box application. In this embodiment, the VOD application has been modified to present to the viewer an option for accessing their Favorites list 304. Otherwise, the VOD service proceeds as it would otherwise and present the VOD library titles at step 324. For purposes of illustration, it is assumed the viewer elects to access their Favorites List 304.

The process 304 may incorporate an identification/verification step 306. This step is optional, and allows multiple Favorites Lists to be maintained for a single serving location. If there is only one individual at the service location, or only one Favorites List per serving location, then this step may be omitted, or modified to merely verify the user. If there is only one Favorites List, then a single Favorite List per account may be allowed.

The next step 308 involves the FLMS retrieving list data stored for the viewer from a data store, and presenting it to the viewer. The list of titles can be presented in various formats, and utilize categories, search functions, subheadings, and other techniques known in the art for presenting information. The viewer may select one of the movie titles in the list in step 310, and then invoke various functions pertaining to that title. This menu may be formatted as shown in FIG. 1.

One function that the viewer can invoke after selecting a particular movie title is the View Movie Details 312 function, which presents information about the movie, including actors, year produced, plot summary, etc. This may include information about when the movie will be available if it is not presently in the VOD library, or a date at which the movie title will no longer be available if it is in the VOD library. Another function is the Delete Title 314 function. This removes the movie title from the Favorites List, and may be used by a viewer to “clean up” the list or reflect the viewer's changing preferences.

The function “Add Title to Favorites” 316 operates a little differently in that the function does not act on a presently selected title. Specifically, invocation of this function results in a user-interface presented that is configured to prompt the user to enter the name of a title, or allow the user to select a title from the VOD menu. In summary, the “Add Title to Favorites List” presumes that the title is not in the Favorites List, and therefore the user identifies a title to add to the list. In some embodiments, the title added may not yet be presently in the VOD library, as it reflects a title which the user requests notification of when it is available.

The “Play Movie” function 318 allows the user to view the indicated movie. The set top box may rely on the existing VOD procedures to request playing of the indicated title.

The “Go To VOD Menu” function 320 allows the user to navigate the titles in the VOD Menu, and facilitates traversing between the VOD Library titles and the Favorites List titles.

Finally, the “Recommend Title” function 322, requests that the FLMS system recommend a title that the viewer may like based on various criteria and invokes the Recommend Titles function 334. The algorithm used can be one of several publicly defined algorithms or based on a proprietary algorithm, and can considerer the entries in the viewer's Favorite List. The algorithm may consider movie ratings, frequency of viewing, year, type and actors. As a result, the FLMS may indicate a list of titles at step 336, to which the viewer can select a movie and add it to the Favorites List in step 338. The recommendation may also include an indication of when the movie will be available, or when it will not longer be available. Further functions may be defined (e.g., “View Movie Details”). The list of recommended movie titles may be considered as a separate menu page from the Favorites List menus, and hence the user may request in step 342 to return to the Favorites List menu page, or go to the VOD Menu page in step 340. Many variations are possible, and are within the scope of the present invention.

The other set of functions in the VOD menu 324, which comprises functions such as View Movie Details 326, Add to Favorites List 328, Recommend Title 330, and Play Movies 332. These functions are the same as discussed. Other functions may be indicated.

In one embodiment, the menu can be generated by the set top box using existing graphical user interface mechanisms. Various types of user interface techniques can be utilized to present the information and to navigate the various screens. In other embodiments, the FLMS can be located in the cable headend which can generate the user interface using existing techniques.

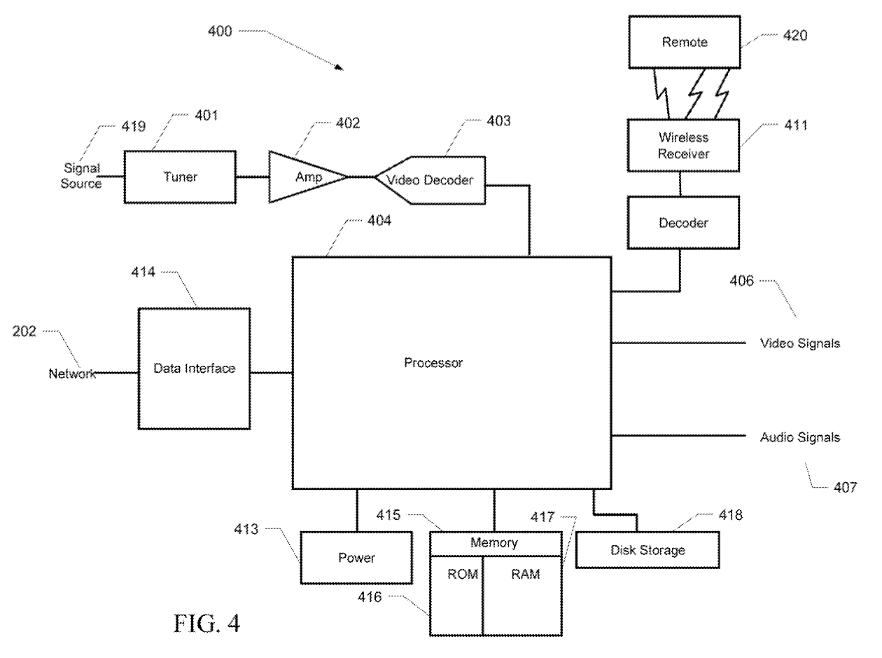

As previously indicated, in one embodiment the FLMS can reside in the set top box, and can be implemented using software executing on a processor in the set top box, which interacts with the VOD application. One embodiment of the structure for the FLMS is shown in FIG. 4. In FIG. 4, the FLMS 400 comprises a processor 404, which executes the Favorites List program instructions stored in memory 415, specifically RAM 417. In other embodiments, the instructions may be stored in ROM 416, and executed from there. Other forms of memory can be used. The program instructions may also be stored in a hard disc storage unit 418 and loaded into memory as required. The processor receives the Favorites List data from the coaxial cable 202, including data interface 414 which receives VOD titles and Favorites related data on a periodic basis. This data would include removal dates for titles, or anticipated availability dates for other titles.

The set top box also includes a tuner 401 for receiving video signal 419 (which is also received on the same coaxial cable, but which is shown as a separate input for illustration purposes). The video signal is processed by an amplifier 402 and video decoder 403. Other components may be involved, but are not relevant to illustrate the present invention. The processor provides the appropriate video signal 406 and audio signal 407 to the television set. The system 400 also includes a remote controller 420, which interfaces with a wireless receiver 411, and an associated decoder to provide input signals to the processor.

The embodiment of FIG. 4 can be readily adapted to a system residing in the headend. Such a system would still incorporate at least the processor, data interface (which would receive data from the VOD system or an administrative management system regarding availability limitations for viewing a title), and memory. However, the functions necessary for decoding a video signal in the set top box would not be necessary. Further, signaling from a user indicating menu functions and selections using the remote control would have to be relayed by the set top box to the headend to the System.

### System Operation

Exemplary use of the overall system operation can now be described using the above described figures. The VOD system periodically receives updates of upcoming movies, changes to the VOD library, etc., which are loaded into the VOD system 235 via an administrative interface. The VOD system 235 periodically transmits information about changes regarding titles in the VOD library to the set top box 205. Thus, when the user request the VOD service, the viewer can readily view titles available from the VOD system. These menus are generated by the set top box and presented to the viewer using the television set 206.

The user can access the VOD service using the remote control unit 420. In this embodiment, the user is then prompted as to whether they would like to access their Favorites List 304. If so, the set top box then accesses any Favorites List data stored in memory 417 and presents the Favorites List to the user 310. The user will be presented with a list of movies titles 100, as shown in FIG. 1, which includes various functions 102-112 and the dates 113, 116 that the titles are expected to be available or will no longer be available. The FLMS system can also alert the viewer of new titles in the VOD menu that are likely to be of interest to the viewer. In this manner, the user can be informed if a movie title is being added, or being removed, from the VOD data store 234 without having to check the VOD menu (which may provide information on titles the viewer is not interested in). The viewer can then elect to “play” a selected movie in the Favorites List based on its limited availability.

Alternately, the viewer may elect to navigate from the Favorites List 320 to the VOD Menu to view movies which are stored in the VOD library. However, the indication of available or new titles via the VOD menu is not pre-screened or limited for that particular viewer. The viewer may request that the system “recommend” a title 330, which invokes various algorithms to present one or more recommended titles based on the viewer's Favorites List. The viewer may then select a title and add the title to their favorites list 338. The user may then be informed if the title has limited availability.

The present invention provides in one embodiment a system for readily managing the very large and growing number of titles in the VOD library for a particular viewer. The viewer can browse a smaller, more targeted list, which reflects that particular viewer's preferences. The user can be notified when a movie in the viewer's Favorites List will be no longer available, or when a requested movies is available. This makes the VOD library more personalized and easier to use.

1. A method for presenting a favorites list of movie titles comprising the steps of:
receiving at a processor movie title availability data comprising a date corresponding to either
1) a movie title stored in a VOD library associated with a VOD service offered by a cable service provider wherein said date indicates when said movie title will no longer be available for viewing by a cable subscriber using said VOD service, or
2) a movie title that is not stored in said VOD library associated with the VOD service offered by said cable service provider wherein said date indicates when said movie title is expected to be available for viewing by said cable subscriber using said VOD service;
updating a list of movie titles using said movie title availability data, wherein at least a portion of said list of movie titles comprises a subset of movies stored in said VOD library;
receiving a request at a set top box for a viewer using a remote control of a set top box, wherein said viewer is said cable system subscriber, said request comprising a request to view said list of movie titles;
retrieving from memory by a processor at least a subset of said list of movie titles; and
presenting to said viewer at least a subset of said list of movie titles and said movie title availability data.

2. The method of claim 1 wherein request to view said list of movie titles is preceded by a request for said VOD service.

3. The method of claim 1 wherein said movie title availability data presented to said viewer comprises a date at which at least one movie title will no longer be available for viewing by said cable subscriber using said VOD service.

4. The method of claim 1 wherein said step of presenting to said viewer said list of movie titles comprising presenting to said viewer a plurality of functions associated with said list of movie titles.

5. The method of claim 4 wherein one of the plurality of functions comprises a “play movie” function resulting invoking said VOD service.

6. The method of claim 3 further comprising the steps:
Providing viewer identification data; and
Selecting said list of movie titles associated with said viewer identification data.

7. The method of claim 1 wherein said list of movie titles comprises a list of movie titles wherein each movie title has been requested by said viewer to be included in said list of movie titles.

8. The method of claim 1 wherein said list of movie titles comprises a user-provided rating indication.

9. The method of claim 1 wherein said list of movie titles comprise a first movie title with a first date indicating when said movie title will no longer be available for viewing by said cable subscriber using said VOD service
and
a second movie title with a second date indicating when said movie title will be available for viewing by said cable subscriber using said VOD service.

10. A system for providing a list of movie titles to a cable subscriber comprising:
an interface configured to receive movie title availability data;
a memory storing said list of movie titles and storing movie title availability data comprising a date corresponding to either
1) a movie title stored in a VOD library associated with a VOD service offered by a cable service provider wherein said date indicates when said movie title will no longer be available for viewing by said cable subscriber using said VOD service, or
2) a movie title that is not stored in said VOD library associated with the VOD service offered by said cable service provider wherein said date indicates when said movie title is expected to be available for viewing by said cable subscriber using said VOD service;
a processor configured to:
receive said movie title availability data and update said list of movies titles stored in said memory wherein at least a portion of said favorite list of movie titles comprises a subset of movies stored in said VOD library;
receive a request from a viewer using a remote control of a set top box, wherein said viewer is said cable system subscriber, said request comprising a request to view said list of movie titles;
retrieve from memory by said processor said list of movie titles; and
present to said viewer at least a subset of said list of movie titles and said movie title availability data.

11. The system of claim 10 wherein said processor is configured to receive a request from said cable subscriber invoking said VOD service.

12. The system of claim 10 wherein said movie title availability data comprising said date is associated with a movie title stored in a VOD library associated with said VOD service offered by said cable service provider wherein said date indicates when said movie title will no longer be available for viewing by said cable subscriber using said VOD service.

13. The system of claim 10 wherein the processor is configured to present to said viewer a list of functions capable of being invoked by said cable subscriber with said list of movie titles.

14. The system of claim 13 wherein the processor is configured to receive a function request from said viewer indicating a particular movie title is to be played.

15. The system of claim 10 wherein said processor is configured to receive viewer identification data and retrieve said list of movie titles wherein said list is associated with said viewer identification data.

16. The system of claim 10 wherein said interface is configured to receive said movie title availability data from over a cable distribution network from a cable system headend.

17. The system of claim 13 wherein said processor is configured to receive input provided by said viewer using a remote controller wherein said input requests invocation of one of said functions resulting in invoking said VOD service.

18. The system of claim 13 wherein one of said functions causes said processor to identify a similar movie title wherein said similar movie title is not included in said list of movie titles. particular movie corresponding to be streamed to a set top box associated with said viewer using said VOD service.

19. The system of claim 10 wherein said processor is configured to modify said list of movie titles based on said movie title availability data and store said modified list of movie titles in said memory.

20. The system of claim 19 wherein said processor is configured to delete a particular movie title in said list of movie titles.
